(19) United States
(12) Patent Application Publication
(10) Pub. No.: US 2026/0156121 A1
(43) Pub. Date: Jun. 4, 2026

(54) FRAMEWORK FOR ADMINISTRATORS PERFORMING MANAGEMENT ACTIONS ACCESSING RESOURCES OF A COMPUTING ENVIRONMENT

(71) Applicant: YugabyteDB, Inc., Sunnyvale, CA (US)

(72) Inventors: Jagdish Shinde, Bangalore (IN); Harshitha Vontela, Bangalore (IN); Karthik Chandrasekaran, Bangalore (IN); Krishnan Srinath, Bangalore (IN); Pavithra Nachukuru, Bangalore (IN)

(21) Appl. No.: 18/992,589

(22) PCT Filed: Jul. 31, 2024
(86) PCT No.: PCT/US2024/040255

§ 371 Date: Jan. 9, 2025

(51) Int. Cl. H04L 9/40

(52) U.S. Cl. CPC H04L 63/105

(57) ABSTRACT

An aspect of the present disclosure is directed to providing access to resources of a computing environment. In one embodiment, a (digital processing) system maintains a configuration data specifying for each management action of multiple management actions, a corresponding set of resource-actions that are to be permitted. Upon receiving a create request specifying a custom role and a set of management actions permitted for the custom role, the system identifies based on the configuration data and the set of management actions, an effective set of resource-actions that are to be permitted for the custom role. The system stores, as part of a role data, the custom role associated with the effective set of resource-actions and enabling the custom role to be assigned to a set of administrators, such that each administrator is permitted to perform the effective set of resource-actions in view of the identifying and the storing.

### BACKGROUND OF THE DISCLOSURE

### Technical Field

The present disclosure relates to enterprise systems and more specifically to a framework for administrators performing management actions accessing resources of a computing environment.

### Related Art

Computing environments contain computing infrastructures and software applications deployed thereon for processing user requests received from end-users. The computing infrastructures can be cloud infrastructures, enterprise infrastructures, a hybrid of cloud and enterprise infrastructures, as is well known in the relevant arts.

Resources in computing environments commonly constitute hardware elements, software elements or a combination thereof, as is well known in the relevant arts. Examples of resources thus include nodes, clusters, VPC (virtual private clouds), API (application programming interface) keys, Alerts, etc.

Management actions effect desired changes in the resources of the computing environment that are thereafter made available to potentially all end-users of the computing environment. As such, management actions are commonly performed by administrators of the computing environment. Examples of management actions include add/create, delete, update, configure, etc., of the resources noted above.

As environments become complex (e.g., large enterprises) having a large number of administrators, there is a general need for frameworks that are simple and yet provide control in permitting administrators to perform management actions.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2A is a flowchart illustrating the manner in which administrators are facilitated to create new custom roles and corresponding users according to aspects of the present disclosure.

FIG. 2B is a flowchart illustrating the manner in which administrators are facilitated to perform management actions accessing resources of a computing environment according to aspects of the present disclosure.

FIG. 3A is a block diagram illustrating the manner in which a software application is implemented in one embodiment.

FIG. 3B depicts portions of an operation data maintained in one embodiment.

FIG. 4A depicts portions of a configuration data maintained in one embodiment.

FIG. 4B depicts portions of a create request received for a custom role in one embodiment.

FIG. 4C illustrates a dependency graph showing the dependencies among management actions and resource actions in one embodiment.

FIG. 4D depicts portions of an effective set of resource-actions identified in one embodiment.

FIG. 5A depicts portions of a role data in one embodiment.

FIG. 5B depicts portions of a user data in one embodiment.

FIG. 6A is a block diagram depicting the implementation of an access management tool in one embodiment.

FIG. 6B illustrates the manner in which an access management tool is deployed in a computing environment in different embodiments.

FIG. 7A depicts portions of operation data corresponding to a new functionality in one embodiment.

FIG. 7B depicts portions of configuration data corresponding to a new functionality in one embodiment.

FIG. 7C depicts portions of configuration data updated to reflect the addition of a new functionality in one embodiment.

FIG. 7D depicts portions of an effective set of resource-actions updated to reflect the addition of a new functionality in one embodiment.

FIGS. 8A-8H illustrate sample user interfaces that provide a framework for administrators performing management actions accessing resources of a computing environment in one embodiment.

FIG. 9 is a block diagram illustrating the details of a digital processing system in which various aspects of the present disclosure are operative by execution of appropriate

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure is directed to providing access to resources of a computing environment. In one embodiment, a (digital processing) system maintains a configuration data specifying for each management action of multiple management actions, a corresponding set of resource-actions that are to be permitted. Upon receiving a create request specifying a custom role and a set of management actions permitted for the custom role, the system identifies based on the configuration data and the set of management actions, an effective set of resource-actions that are to be permitted for the custom role. The system stores, as part of a role data, the custom role associated with the effective set of resource-actions and enabling the custom role to be assigned to a set of administrators, such that each administrator is permitted to perform the effective set of resource-actions in view of the identifying and the storing.

According to another aspect of the present disclosure, the configuration data further specifies for each management action, a corresponding set of management actions that are to be permitted. The system then performs the identifying (noted above) by constructing, based on the configuration data, a dependency graph for the set of management actions, wherein the dependency graph contains start nodes representing the set of management actions, intermediate nodes representing the corresponding set of management actions and end nodes representing the corresponding set of resource-actions. The system includes the management actions or the resource-actions representing all of the nodes in the dependency graph in the effective set of resource-actions.

According to one more aspect of the present disclosure, the create request is received from a first end-user system. The system sends for display, to the first end-user system, the effective set of resource-actions to indicate that each resource-action of the effective set of resource-actions is also permitted for the custom role.

According to yet another aspect of the present disclosure, the effective set of resource-actions include the set of management actions (specified as part of the create request). Upon receiving, from an administrator, an access request for performance of a management action, the system determines that the custom role is assigned to the administrator, and retrieves, from the role data, the effective set of resource-actions permitted for the custom role. Accordingly, the system checks whether the effective set of resource-actions includes the management action. If the checking determines that the effective set of resource-actions includes the management action, the system allows performance of the management action and the effective set of resource-actions and otherwise, denies performance of the management action.

According to an aspect of the present disclosure, the access request (noted above) is for performance of a resource-action, with the system allowing performance of the resource-action if the effective set of resource-actions includes the resource-action.

According to another aspect of the present disclosure, a software application deployed in the computing environment exposes a set of APIs (application programming interfaces), with the access request (noted above) corresponding to invocation of an API. The system maintains an operation data that maps each API of the set of APIs to a corresponding management action and finds, in response to the access request, that the access request is for performance of the management action based on the operation data and the API. The action of checking (noted above) is performed after the finding.

According to one more aspect of the present disclosure, the configuration data specifies for a first management action, a first set of resource-actions that are to be permitted. Upon receiving, from a system administrator, a change request indicating that the first set of resource-actions is to be replaced by a second set of resource-actions, the system updates the configuration data to specify for the first management action, the second set of resource-actions. For each custom role in the role data containing the first management action, the system performs the above noted actions of identifying and the storing based on the updated configuration data.

According to yet another aspect of the present disclosure, the second set of resource-actions includes a new resource-action corresponding to a new functionality.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

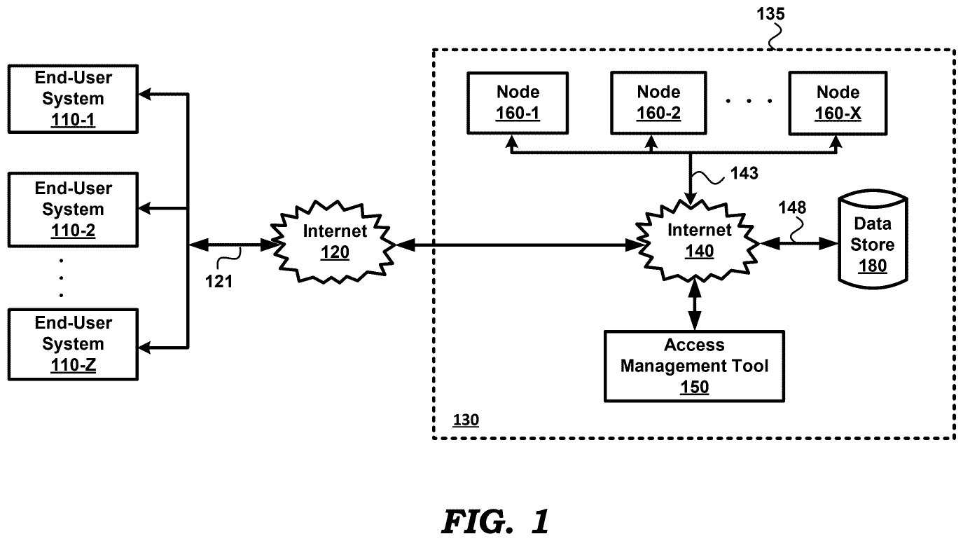

FIG. 1 is a block diagram illustrating an example environment in which several aspects of the present disclosure can be implemented. The block diagram is shown containing end-user systems 110-1 through 110-Z (Z representing any natural number), Internet 120, and computing infrastructure 130. Computing infrastructure 130 in turn is shown containing intranet 140, nodes 160-1 through 160-X (X representing any natural number), access management tool (AMT) 150 and data store 180. The end-user systems and nodes are collectively referred to by 110 and 160 respectively.

Merely for illustration, only representative number/type of systems are shown in FIG. 1. Many environments often contain many more systems, both in number and type, depending on the purpose for which the environment is designed. Each block of FIG. 1 is described below in further detail.

Computing infrastructure 130 is a collection of nodes (160) that may include processing nodes, connectivity infrastructure, data storages, administration systems, etc., which are engineered to together host software applications. Computing infrastructure 130 may be a cloud infrastructure (such as Amazon Web Services (AWS) available from Amazon.com, Inc., Google Cloud Platform (GCP) available from Google LLC, etc.) that provides a virtual computing infrastructure for various customers (commonly referred to as “tenants”), with the scale of such computing infrastructure being specified often on demand.

Alternatively, computing infrastructure 130 may correspond to an enterprise system (or a part thereof) on the premises of the customers (and accordingly referred to as “On-prem” infrastructure). Computing infrastructure 130 may also be a “hybrid” infrastructure containing some nodes of a cloud infrastructure and other nodes of an on-prem enterprise system, as will be apparent to one skilled in the relevant arts.

All of nodes 160 and other systems (such as AMT 150 and data store 180) in computing infrastructure 130 are connected via intranet 140. Internet 120 extends the connectivity of these (and other systems of the computing infrastructure) with external systems such as end-user systems 110. Each of intranet 140 and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and intranet 140. When the packet contains content such as port numbers, which specifies a target application, the packet may be said to be directed to such application as well.

Each of end-user systems 110 represents a system such as a personal computer, workstation, mobile device, computing tablet etc., used by users to generate (user) requests directed to software applications executing in server systems of computing infrastructure 130. A user request refers to a specific technical request (for example, Universal Resource Locator (URL) call) sent to a server system from an external system (here, end-user system) over Internet 120, typically in response to a user interaction at end-user systems 110. The user requests may be generated by users using appropriate user interfaces (e.g., web pages provided by an application executing in a node, a native user interface provided by a portion of an application downloaded from a node, etc.).

In general, an end-user system requests a software application for performing desired tasks and receives the corresponding responses (e.g., web pages) containing the results of performance of the requested tasks. The web pages/responses may then be presented to a user by a client application such as the browser. Each user request is sent in the form of an IP packet directed to the desired system or software application, with the IP packet including data identifying the desired tasks in the payload portion.

Some of nodes 160 may be implemented as corresponding data stores. Each data store (including data store 180) represents a non-volatile (persistent) storage facilitating storage and retrieval of enterprise by software applications executing in the other systems/nodes of computing infrastructure 130. Each data store may be implemented as a corresponding database server using relational database technologies and accordingly provide storage and retrieval of data using structured queries such as SQL (Structured Query Language). Alternatively, each data store may be implemented as a corresponding file server providing storage and retrieval of data in the form of files organized as one or more directories, as is well known in the relevant arts.

Some of the nodes 160 may be implemented as corresponding server systems. Each server system represents a server, such as a web/application server, constituted of appropriate hardware executing software applications capable of performing tasks requested by end-user systems 110. A server system receives a user request from an end-user system and performs the tasks requested in the user request. A server system may use data stored internally (for example, in a non-volatile storage/hard disk within the server system), external data (e.g., maintained in a data store) and/or data received from external sources (e.g., received from a user) in performing the requested tasks. The server system then sends the result of performance of the tasks to the requesting end-user system (one of 110) as a corresponding response to the user request. The results may be accompanied by specific user interfaces (e.g., web pages) for displaying the results to a requesting user.

In one embodiment, software applications are deployed in nodes 160 of computing infrastructure 130. The software applications are capable of processing user requests (performing the requested tasks) received from end-user systems 110. Examples of such software applications include, but are not limited to database applications, data processing (e.g., batch processing, stream processing, extract-transform-load (ETL)) applications, Internet of things (IoT) services, mobile applications, and web applications. Computing infrastructure 130 along with the software applications deployed there is viewed as a computing environment (135). In the disclosure herein, computing environment 135 includes computing infrastructure 130 deployed with a fully managed cloud native database-as-a-service (software application) known as YugabyteDB Aeon (previously known as “YugaByteDB Managed”) available from YugaByteDB, Inc. In the following description, the deployed software application is referred to as “YBM”.

Computing environment 135 may provide various resources that may be accessed and used by users using end-user systems 110. The resources may be software resources specific to the implementation of a software application such as API keys, Accounts, Alert Rules, etc., hardware resources such as hardware elements (nodes, network routers, etc.) of computing system 130 or may be mixed resources which are a combination of hardware and software such as clusters, VPC (virtual private clouds), etc.

In one embodiment, each customer/tenant is provided with a corresponding virtual computing infrastructure (referred to as a “cloud”) hosted on computing environment 135. As such, the customer/tenant may wish to control the access of users to the resources of his/her cloud. For example, it may be desirable that users using the software applications for performance of tasks (hereinafter referred to as “cloud users”) be provided just read/execute access for the resources, while users managing the resources, that is, performing management actions, in the cloud(s) (hereinafter referred to as “cloud administrators” or just “administrators”) be provided additional access for creation, update, deletion of the resources. In addition to the above users, there may be users managing the resources of computing environment 135 (hereinafter referred to as “system administrators”).

In a current approach, computing environment 135 provides for role-based access control (RBAC) well known in the relevant arts. Specifically, computing environment 135 provides a set of predefined/built-in roles such as Account Admin, Account Developer and Viewer (Read-only/Auditor), etc. (where “Account” refers to the customer/tenant), where users assigned to each role is permitted to perform a corresponding set of management actions.

However, customers may want flexibility beyond the predefined roles noted above. Specifically, when the customers are large enterprises having a large number of administrators, customers may want the ability to create custom roles in computing environment 135 so that different sets of people (administrators) may manage different aspects of the cloud.

Examples of desirable custom roles are “Cluster Administrator” role who can perform all cluster related operations like, creating a cluster, associating networking and security related configuration to the cluster, update/pause/resume/delete the cluster, take periodic backups etc.; “Cluster Ops Manager” role who can only view cluster details, configure and take backups, view slow queries and different cluster metrics, debug issues etc.; and “Security Admin” role who can manage cloud users onboarding and offboarding, managing roles in the cloud, assigning roles to cloud users etc.

Access management tool (AMT) 150, provided according to several aspects of the present disclosure, provides a framework for administrators performing management actions accessing resources of a computing environment (135). Though shown implemented as a separate system, in alternative embodiments, AMT 150 may be implemented on one of nodes 160 in computing infrastructure 130 or as a system external (connected to Internet 120) to computing infrastructure 130. The manner in which AMT 150 provides a framework for administrators performing management actions is described below with examples.

### 3. Framework for Administrators Performing Management Actions

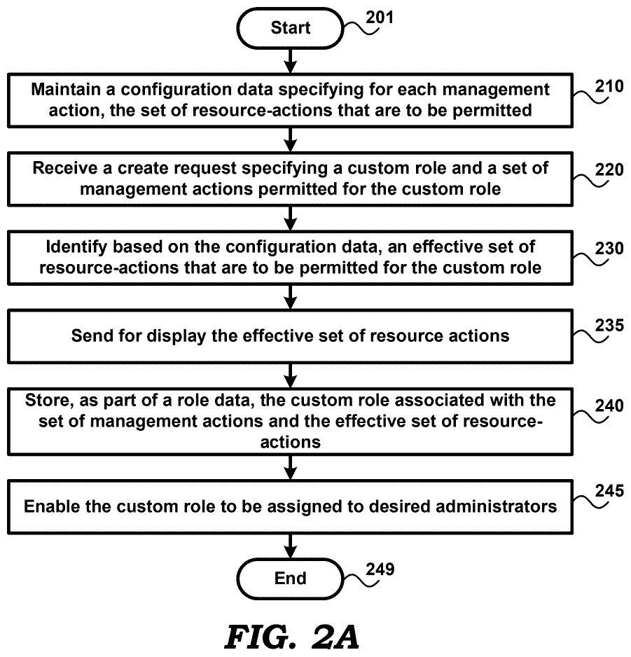

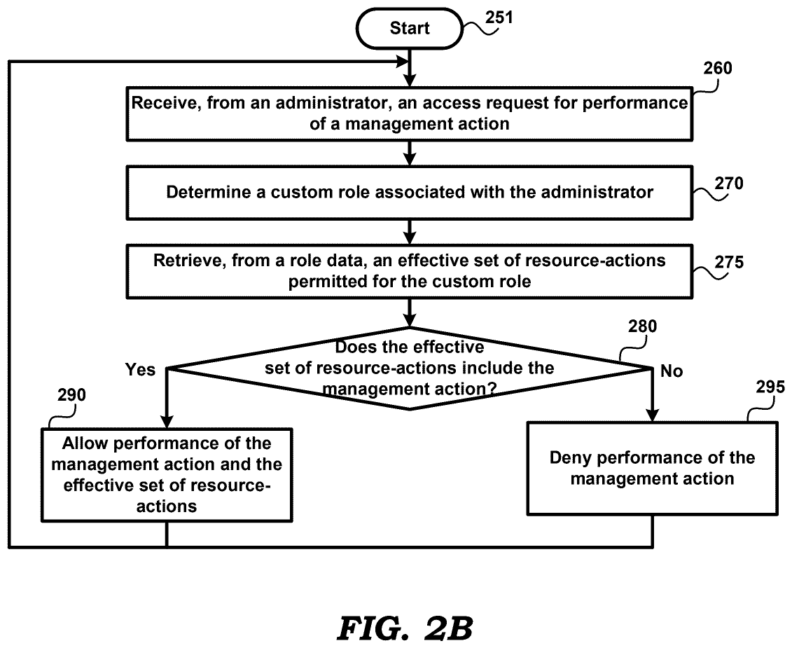

FIGS. 2A and 2B are flow charts together illustrating the manner in which a framework for administrators performing management actions accessing resources of a computing environment (135) is provided according to aspects of the present disclosure. The flowcharts are described with respect to the systems of FIG. 1 in particular AMT 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention.

FIG. 2A is a flowchart illustrating the manner in which administrators are facilitated to create new custom roles and corresponding users according to aspects of the present disclosure. The flow chart begins in step 201, in which control immediately passes to step 210.

In step 210, AMT 150 maintains a configuration data specifying for each management action, the corresponding set of resource-actions that are to be permitted. The configuration data (and other data noted below) may be maintained in data store 180. In alternative embodiments, the configuration data (and other data noted below) may be maintained in a non-volatile memory (such as a hard disk) within AMT 150 or in one of nodes 160 (implemented as a data store).

In the disclosure herein, the term “resource-action” refers to an action (such as create, update, delete, read, etc.) affecting a single resource (such as API key, Allow_List, node, etc.), while the term “management action” refers to an action affecting multiple resources in computing environment 135. Though a management action (e.g., create cluster) may require performance of one or more resource-actions (e.g., read VPC, create Allow_List, etc.), the management action itself may be viewed as an action affecting a “higher-level” resource (here, cluster), that is, as a resource-action. Accordingly, the terms “resource-action” and “management action” are used interchangeably herein.

The configuration data indicating the relationships between the management actions and the corresponding set of resource-actions is typically specified by a system administrator managing the resources of computing environment 135. The relationships may be determined based on the implementation of the software applications deployed as part of computing environment 135.

In step 220, AMT 150 receives a create request specifying a custom role and a set of management actions permitted for the custom role. The create request may be received from one of end-user systems 110, in response to an administrator specifying the details of the request using appropriate interfaces provided by AMT 150 (an example of which is described in detail in below sections).

In step 230, AMT 150 identifies based on the configuration data, an effective set of resource-actions that are to be permitted for the custom role. The effective set of resource-actions includes the permitted set of management actions specified in the create request. In addition, each management action is looked-up in the configuration data to determine the corresponding set of resource-actions, and the determined set is included in the effective set.

According to an aspect, the configuration data further specifies for each management action, a corresponding set of management actions that are to be permitted. As such, for identifying the effective set, AMT 150 first constructs a dependency graph having start nodes representing the received set of management actions, intermediate nodes representing the corresponding set of management actions (as per the configuration data) and end nodes representing the corresponding set of resource-actions (as per the configuration data). AMT 150 then includes the management actions or the resource-actions representing all of the nodes in the dependency graph in the effective set of resource-actions.

In step 235, AMT 150 sends for display the effective set of resource-actions. The effective set may be sent to the end-user system 110 from which the create request was received in step 220. The effective set may thereafter be displayed to the administrator, thereby enabling the administrator to know the additional resource-actions that are permitted for the custom role to facilitate the performance of the set of management actions.

In step 240, AMT 150 store, as part of a role data, the custom role associated with the effective set of resource-actions. The role data may be maintained in data store 180.

In step 245, AMT 150 enables the custom role to be assigned to desired (one or more) administrators. The assignment of the custom role to desired administrators may be performed using appropriate interfaces provided by AMT 150 (an example of which is described in detail in below sections). Each administrator assigned the custom role is thereafter permitted to perform the effective set of resource-actions in view of the steps of identifying and storing noted above. Control then passes to step 249, where the flow chart ends.

It may be appreciated that a “super” administrator of a cloud may perform steps 210 through 245 to create multiple custom roles specific to the cloud and thereafter assign the custom roles to the desired (other) administrators of the cloud. In some embodiments, the super administrator may also be assigned specific custom roles. The assignments between the custom roles and the administrators may be maintained/stored as part of a user data. The manner in which an administrator is facilitated to perform management actions in computing environment 135 is described in detail below.

### 4. Accessing Resources of a Computing Environment

FIG. 2B is a flowchart illustrating the manner in which administrators are facilitated to perform management actions accessing resources of a computing environment (135) according to aspects of the present disclosure. The flow chart begins in step 251, in which control immediately passes to step 260.

In step 260, AMT 150 receives, from an administrator, an access request for performance of a management action. The access request may be received from one of end-user systems 110, in response to the administrator interacting with appropriate interfaces provided by AMT 150 (an example of which is described in detail in below sections).

In step 270, AMT 150 determines a custom role assigned to the administrator. The custom role may be determined based on the user data noted above.

In step 275, AMT 150 retrieves, from a role data, an effective set of resource-actions permitted for the custom role. The role data here refers to the same role data stored in step 240, and contains one or more custom roles associated with the corresponding effective set of resource-actions.

In step 280, AMT 150 checks whether the effective set of resource-actions includes the management action specified in the access request. If the effective set includes the management action, control passes to step 290 and to step 295 otherwise.

In step 290 AMT 150 allows the performance of the (requested) management action and the effective set of resource-actions (required for performance of the requested management actions). As such, an indication that the administrator is allowed to perform the management action may be sent as a response to the access request. Alternatively, AMT 150 may forward the request to nodes 160 for performance of the management action. The result of performance of the requested management action may thereafter be provided as a response to the access request. Control passes to step 260, where subsequent access requests are processed.

In step 295, AMT 150 denies the performance of the management action. As such, an indication that the administrator is denied to perform the management action may be sent as a response to the access request. Appropriate response/user interfaces indicating the denial may also be sent to the requesting end-user system. Control passes to step 260, where subsequent access requests are processed.

It may be appreciated that the management action in the access request may be a resource-action, with AMT 150 allowing the performance of the resource-action if the effective set of resource-actions includes the resource-action. In other words, the administrator is facilitated to perform any of the (low level) resource-actions, though the custom role (associated with the administrator) was created with a set of (high level) management actions. Such an ability is provided by AMT 150 by maintaining the configuration data, identifying the effective set and storing the effective set associated with the custom role.

According to an aspect, the software application (YBM) deployed in computing environment 135 exposes a set of APIs (application programming interfaces), with the access request (of step 260) corresponding to invocation of a specific API. AMT 150 maintains an operation data that maps each API of the set of APIs to a corresponding management action. In response to the access request, AMT 150 finds that the access request is for performance of the requested management action based on the operation data and the specific API. AMT 150 performs the checking of step 280 after finding the requested management action.

Thus, AMT 150 provides a framework for administrators performing management actions accessing resources of a computing environment (135). The manner in which AMT 150 provides several aspects of the present disclosure according to the steps of FIGS. 2A and 2B is described below with examples.

### 5. Illustrative Example

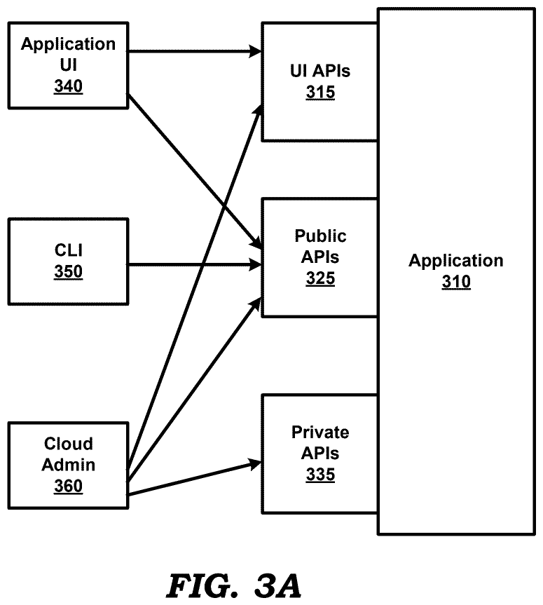

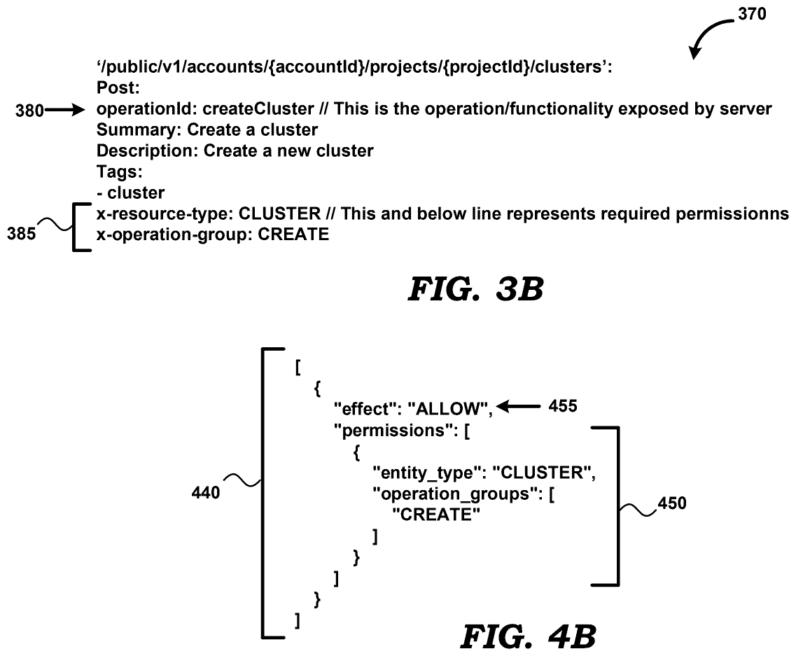

FIGS. 3A-3B, 4A-4D, 5A-5B, 6A-6B, 7A-7D and 8A-8H together illustrate the manner in which a framework for administrators performing management actions accessing resources of a computing environment (135) is provided in one embodiment. Each of the Figures is described in detail below.

FIG. 3A is a block diagram illustrating the manner in which a software application is implemented in one embodiment. Application 310 represents a software application deployed in nodes 160 of computing environment 130. In one embodiment, application 310 corresponds to YBM noted above, and exposes its functionality to clients (such as end-user systems 110) by means of RESTful (REpresentational State Transfer) APIs. These APIs are organized as per OpenAPI Standard Specifications, which is a specification language for HTTP APIs that defines structure and syntax in a way that is not wedded to the programming language the API is created in. The OpenAPI standard allows generation of API clients in multiple languages, helps in documentation and automation, as is well known in the arts. An example of such an HTTP API is “/public/v1/accounts/{accountId}/projects/{projectId}/clusters” that may support REST operations such as GET, POST, PUT, DELETE, etc.

In one embodiment, application 310 (YBM) exposes 170 APIs and over 200 API operations, which are classified into UI (user interface) APIs 315, public APIs 325 and private APIs 335. These APIs are organized in product area specific YAML (YAML Ain't Markup Language) files, for example. cluster lifecycle management related APIs are placed in cluster.yaml whereas user lifecycle management related APIs are placed in user.yaml file. Each API operation is identified by a unique “OperationId”.

Application UI 340 is a graphical user interface used by cloud users to invoke one or more APIs to access the resources of computing environment 135 (via application 310), while CLI 350 is a command line interface for performance of the same access. Cloud Admin 360 is a graphical user interface used by cloud administrators to perform management actions accessing resources of computing environment 135.

It may be appreciated that administrators of the cloud may wish to control access of the various APIs exposed to cloud users/other cloud administrators. According to an aspect, AMT 150 maintains an operation data that maps each API (specifically the operation Id) to a corresponding management action. In response to an access request (which is an invocation of an API), AMT 150 finds the corresponding management action sought to be performed based on mapping in the operation data for the operation Id specified in the invoked API.

FIG. 3B depicts portions of an operation data maintained in one embodiment. Specifically, data portion 370 depicts a portion of a YAML file (“cluster.yaml”) specifying the details of the APIs corresponding to cluster lifecycle management. Data portion 380 indicates operation Id “createCluster” corresponding to an API to be used for creation of a cluster, while data portion 385 indicates the management function “CREATE CLUSTER” mapped to the API. Similarly, other APIs specified in the YAML files may be mapped to corresponding management actions.

It may be appreciated that prior to invocation of an API, administrators are required to setup the desired custom roles and associated management actions that are permitted to be performed by the custom roles. The manner in which administrators are facilitated to specify desired custom roles is described below with examples.

### 6. Specifying Custom Roles

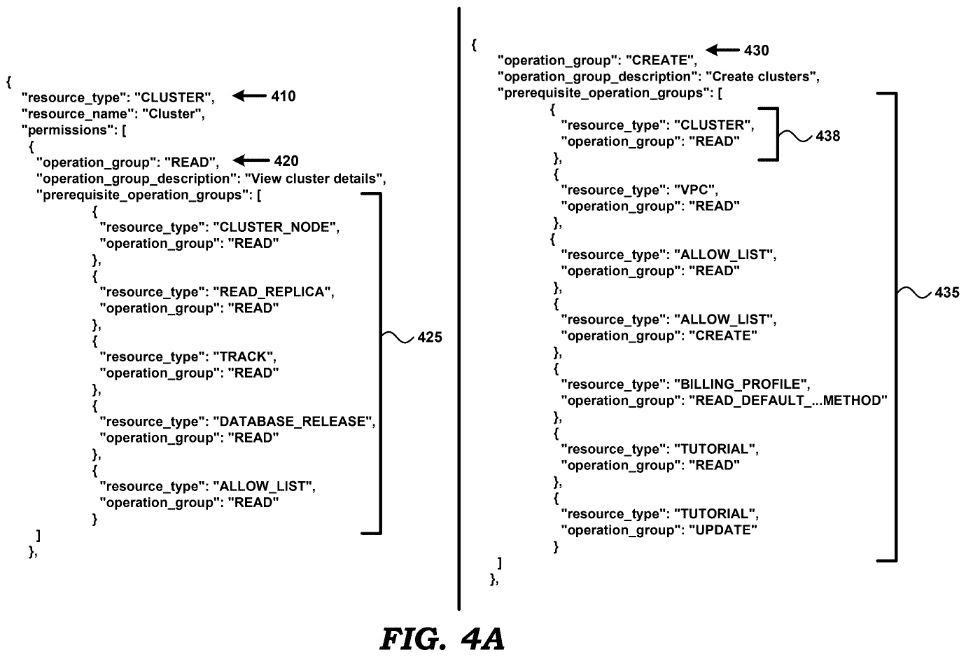

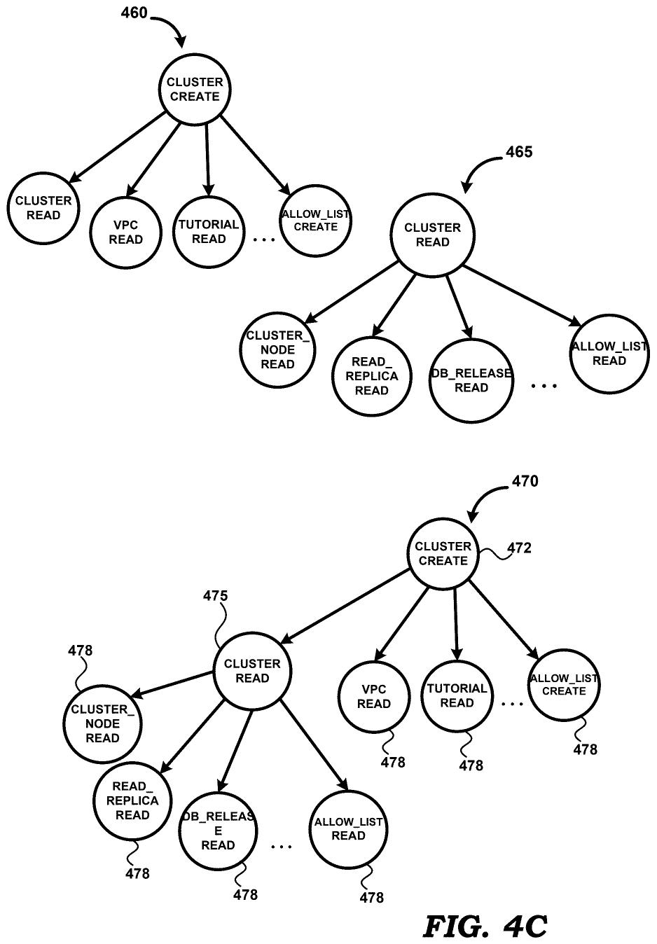

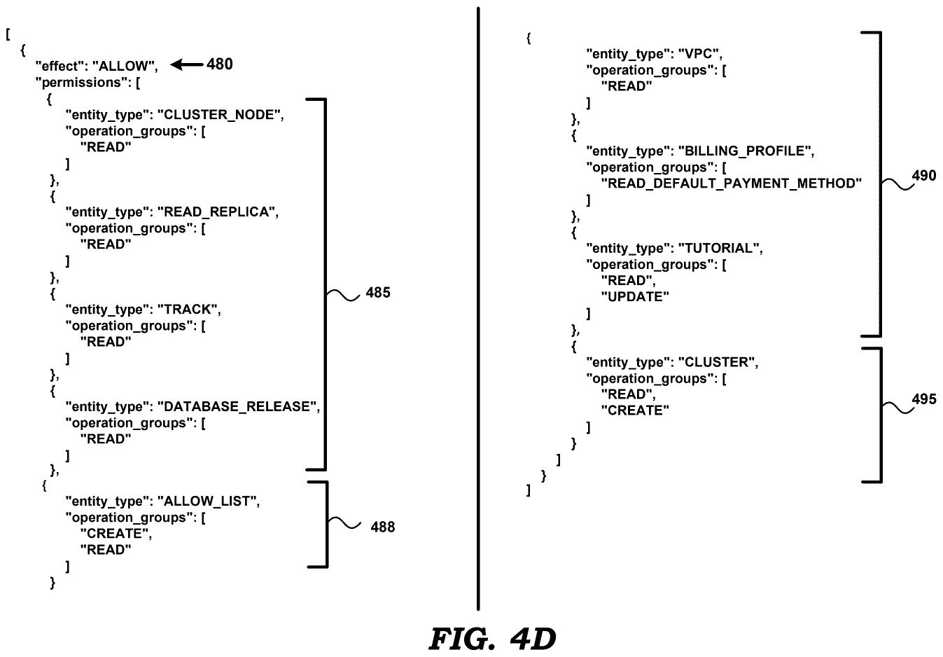

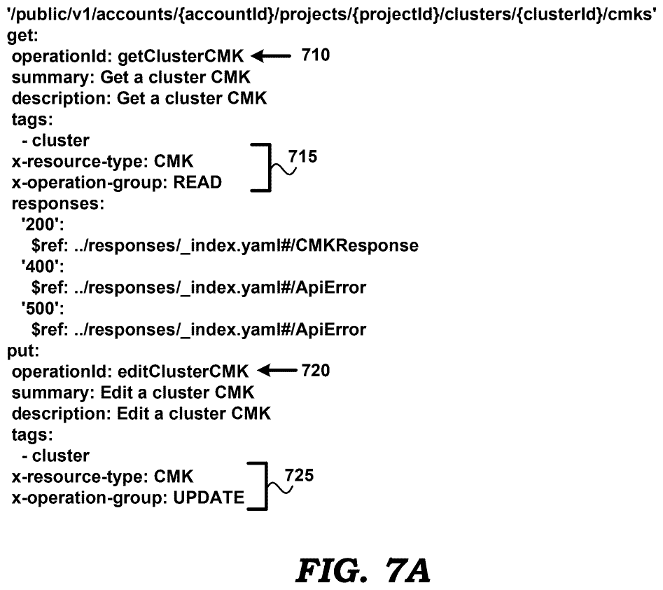

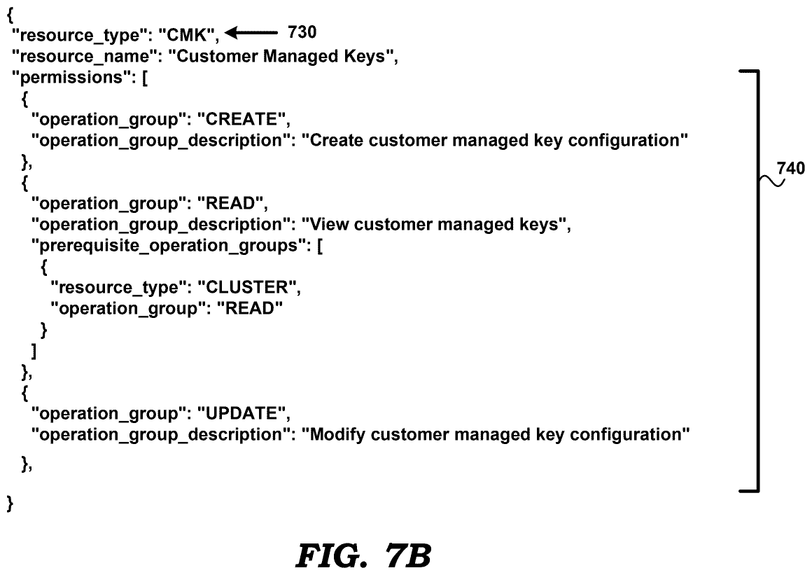

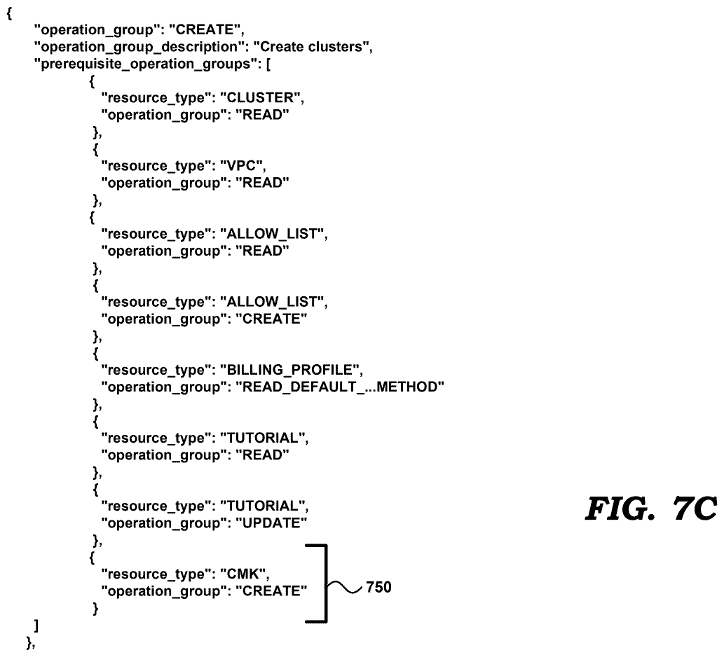

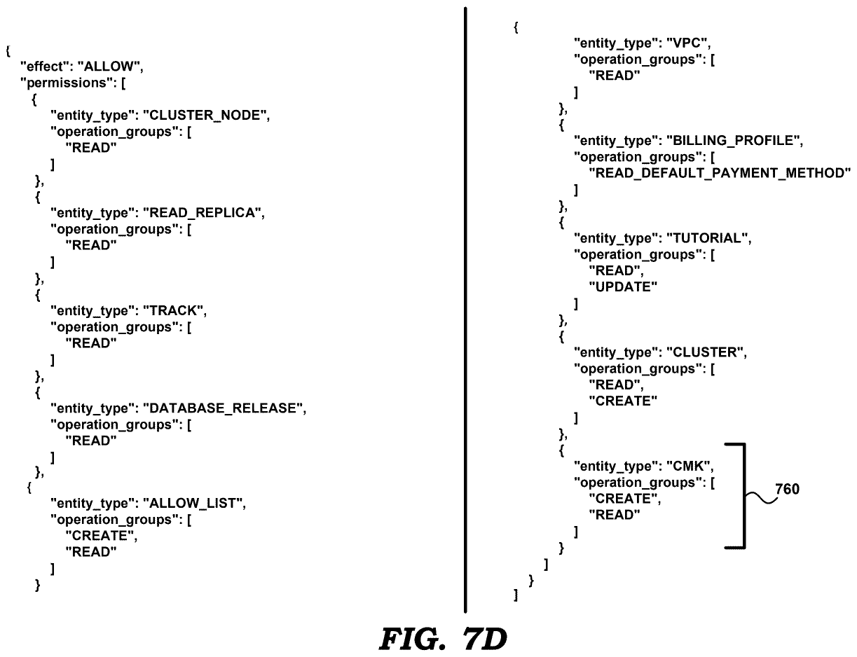

For illustration, the data in FIGS. 4A, 4B, 4D and 7B-7D are shown specified according to JSON (JavaScript Object Notation). However, in alternative embodiments, the data may be maintained according to other data formats (such as extensible markup language (XML), etc.) and/or using other data structures (such as database tables, lists, trees, etc.), as will be apparent to one skilled in the relevant arts by reading the disclosure herein.

FIG. 4A depicts portions of a configuration data maintained in one embodiment. The configuration data is assumed to be maintained in data store 180. Data portion 410 indicates that the resource type to be accessed is “CLUSTER”. Data portion 420 indicates that for the operation “READ” (that is the management action is “CLUSTER READ”), the set of resource actions shown in data portion 425 are required to be permitted/allowed. Similarly, data portion 430 indicates that for the operation “CREATE” (that is the management action is “CLUSTER CREATE”), the set of resource actions shown in data portion 435 are required to be permitted/allowed. It may be observed that data portion 435 includes data portion 438 that refers to another management action “CLUSTER READ”.

Thus, the configuration data specifies for each management action, a corresponding set of resource-actions and management actions that are to be permitted. It may be appreciated that the configuration data defines the interdependencies between different permissions (actions allowed/permitted) as per current state of application 310 (YBM software). In this regard, it may be noted that different applications typically have different configuration data based on their inter implementation. In addition, the same application (310) may have different configuration data (depending on its state) at different time instances.

It may be further noted that though all the resource-actions are explicitly specified in the configuration data, in alternative embodiments, some of the resource-actions/management actions may be implicit. For example, a “READ” management action may be an implicit action required for performance of CREATE, UPDATE and DELETE management actions for the same resource type. As such, AMT 150 ensures that such implicit actions are added by default, when performing the identification of the effective set of resource-actions.

FIG. 4B depicts portions of a create request received for a custom role in one embodiment. The create request is assumed to be received from an administrator using end-user systems 110-1. Specifically, data portion 440 represents a portion of a create request received for the custom role “Cluster Administrator”. Data portion 450 indicates that the specific set of management actions (here, only “CLUSTER CREATE”) that are permitted (as indicated by the value “ALLOW” in data portion 455) for the custom role “Cluster Administrator”.

Upon receipt of a create request, AMT 150 identifies based on the configuration data of FIG. 4A and the received set of management actions, an effective set of resource-actions that are to be permitted for the custom role, the effective set of resource-actions including the set of management actions. For example, if the create request includes the management action “CLUSTER READ” (instead of “CLUSTER CREATE” in data portion 450), AMT 150 may identify the resource-actions shown in data portion 425 corresponding to data portion 420 “CLUSTER READ” and the management action “CLUSTER READ” as the effective set of resource-actions.

However, upon receipt of a create request of FIG. 4B (having “CLUSTER CREATE” in data portion 450), AMT 150 first determines that the set of resource-actions of data portion 435 corresponding to data portion 430 “CLUSTER CREATE” includes other management actions. It may be noted that the other management actions in turn may require other resource-actions to be permitted/allowed. According to an aspect, AMT 150 constructs, based on the configuration data (of FIG. 4A), a dependency graph for the received set of management actions (data portion 450) as described in detail below.

FIG. 4C illustrates a dependency graph showing the dependencies among management actions and resource actions in one embodiment. Broadly, AMT 150 constructs a dependency graph containing start nodes representing the received set of management actions (data portion 450), intermediate nodes representing the determined set of management actions (data portion 438) and end nodes representing the corresponding set of resource-actions (data portions 425 and 435).

Specifically, graph portions 460 and 465 respectively illustrate the dependency graphs corresponding to the management actions “CLUSTER CREATE” and “CLUSTER READ”. As graph portion 460 includes a reference to “CLUSTER READ”, graph portions 460 and 465 may be combined to form graph portion 670. Similarly, other management actions may be replaced with corresponding graph portions to form the dependency graph. It may be observed that 472 is a start node, 475 is an intermediate node and 478 are end nodes.

AMT 150 then includes the management actions and the resource-actions representing all of the nodes (472, 475 and 478) in the dependency graph (47) in the effective set of resource-actions corresponding to the received custom role, as described in detail below.

FIG. 4D depicts portions of an effective set of resource-actions identified in one embodiment. Specifically, the Figure depicts the effective set identified for the create request of FIG. 4B based on the configuration data of FIG. 4A. Data portion 480 indicates that the effective set of resource-actions are permitted/allowed. Data portion 485 substantially includes the resource-actions shown in data portion 425, while data portion 490 substantially includes the resource-actions shown in data portion 435. Data portion 488 indicates the resource-actions permitted in a compact form, while data potion 490 indicates the management actions allowed/permitted and includes the management actions received in the create request.

AMT 150 then stores, as part of a role data, the received custom role “Cluster Administrator” associated with the effective set of resource-actions (of FIG. 4D). AMT 150 also enables the custom role to be assigned to a set of administrators, such that each administrator is permitted to perform the effective set of resource-actions in view of the identifying and the storing. In one embodiment, AMT 150 stores the assignment of the administrators to roles as part of a user data. The manner in which role data specifying the details of custom roles and user data specifying assignment of custom roles to administrators/users is stored/maintained is described below with examples.

### 7. Role Data and User Data

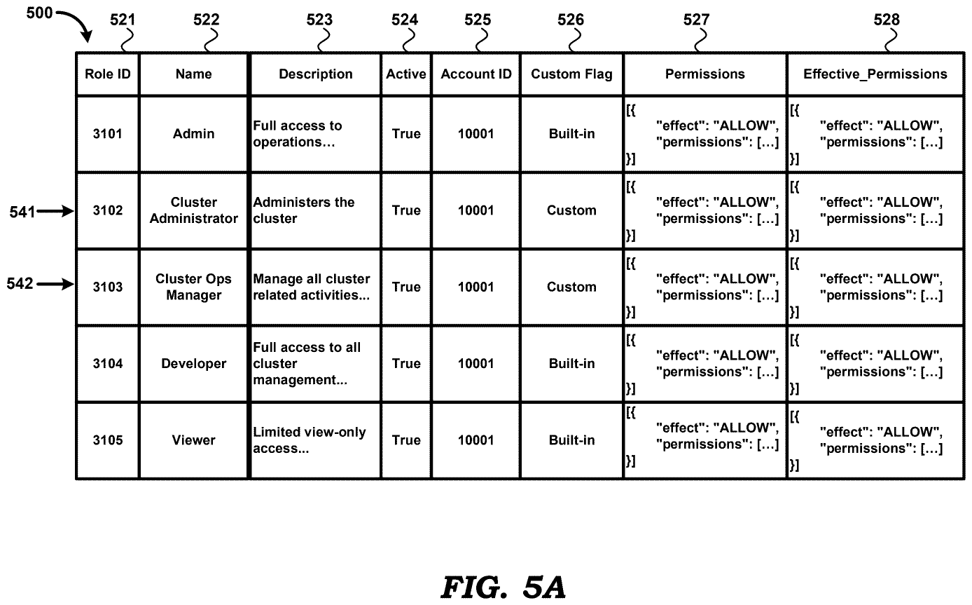

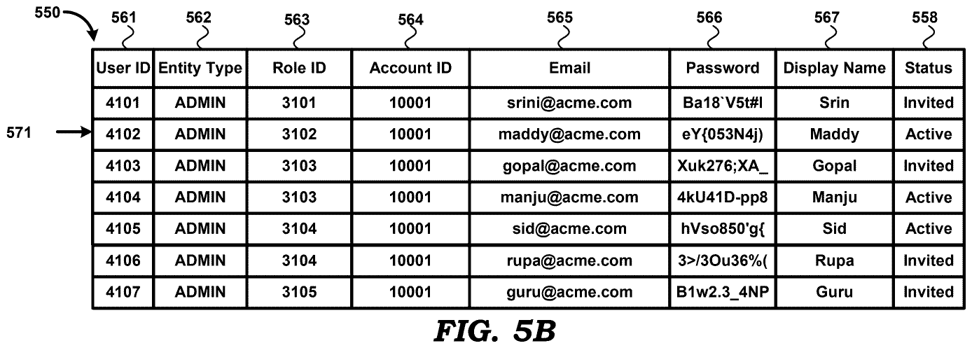

For illustration, the data in FIGS. 5A and 5B are assumed to be maintained as databases tables in data store 180. However, in alternative embodiments, the setup data may be maintained according to other data formats (such as extensible markup language (XML), JSON (JavaScript Object Notation), etc.) and/or using other data structures (such as lists, trees, etc.), as will be apparent to one skilled in the relevant arts by reading the disclosure herein.

FIG. 5A depicts portions of a role data in one embodiment. Table 500 depicts a portion of the role data maintained in data store 180. Column 521 “Role ID” specifies a unique identifier for a role, column 522 “Name” specifies a name (displayed) for the role, column 523 “Description” specifies a description for the role, column 524 “Active” specifies whether the role is active (value “True”) or not (value “False”), column 525 “Account ID” specifies the account/tenant for whom the role is applicable, column 526 “Custom Flag” specifies whether the role is a predefined role (value “Built-in”) or a custom role (value “Custom”), column 527 “Permissions” specifies the management actions that are permitted/allowed for the role, and column 528 “Effective_Permissions” specifies the effective set of resource-actions/management permitted/allowed for the role. It should be noted that columns 527 and 528 store JSON data.

Each of the rows in table 500 specifies the details of a corresponding role. For example, rows 541 and 542 specify custom roles specified for the customer/tenant having the account id 10001. It should be noted that in row 541 for the custom role “Cluster Administrator”, column 527 “Permissions” stores the JSON data shown in FIG. 4B, while column 528 “Effective_Permissions” stores the JSON data shown in FIG. 4D. Similarly, other rows specify the details of other built-in/custom roles for the customer/tenant having the account id 10001.

After storing the role data, the roles in table 500 may be assigned to administrators, with such assignments being stored as part of a user data, described in detail below.

FIG. 5B depicts portions of a user data in one embodiment. Table 550 depicts a portion of the user data maintained in data store 180. Column 561 “User ID” specifies a unique identifier for a user, column 562 “Entity Type” specifies a type of the user, column 563 “Role ID” specifies a role associated with the user indicated by the role ID in column 521, column 564 “Account ID” specifies the account/tenant of the user, column 565 “Email” specifies an email of the user that is used as a login, column 566 “Password” specifies an password of the user corresponding to the login (shown encrypted), column 567 “Display Name” specifies a name displayed for the user, and column 568 “Status” specifies a status (such as “Active”, “Invited”, etc.) for the user.

Each of the rows in table 550 specifies the details of a corresponding user. For example, row 571 specifies a user who is an administrator (“ADMIN” in column 562) having the role of “Cluster Administrator” (value “3102” in column 563 corresponding to row 541). Similarly, Similarly, other rows specify the details of other users/administrators for the customer/tenant having the account id 10001.

Thus, AMT 150 stores role data specifying the details of custom roles and user data specifying assignment of custom roles to administrators/users. The assigned administrators may thereafter send (using end-user systems 110) access requests to AMT 150 for performance of desired management actions. The manner in which AMT 150 may be implemented to processes such access requests and also the create requests is described below with examples.

### 8. Access Management Tool

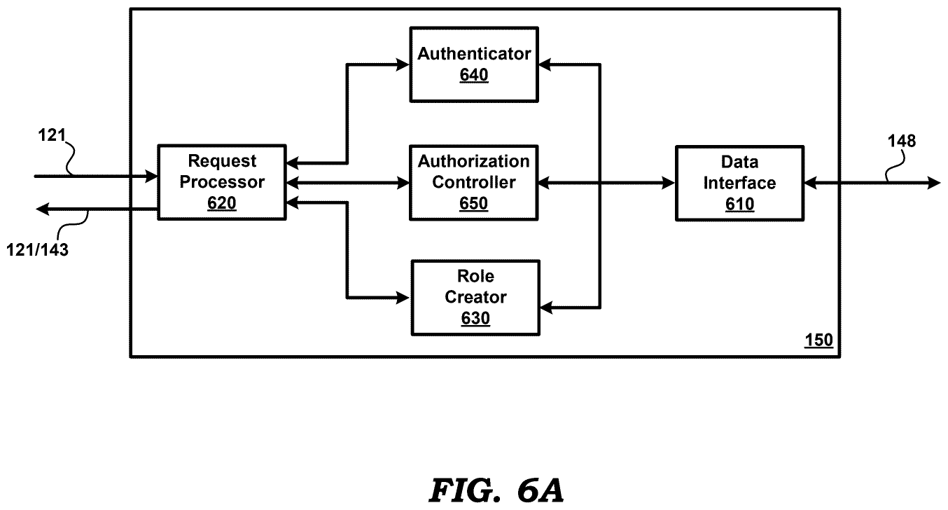

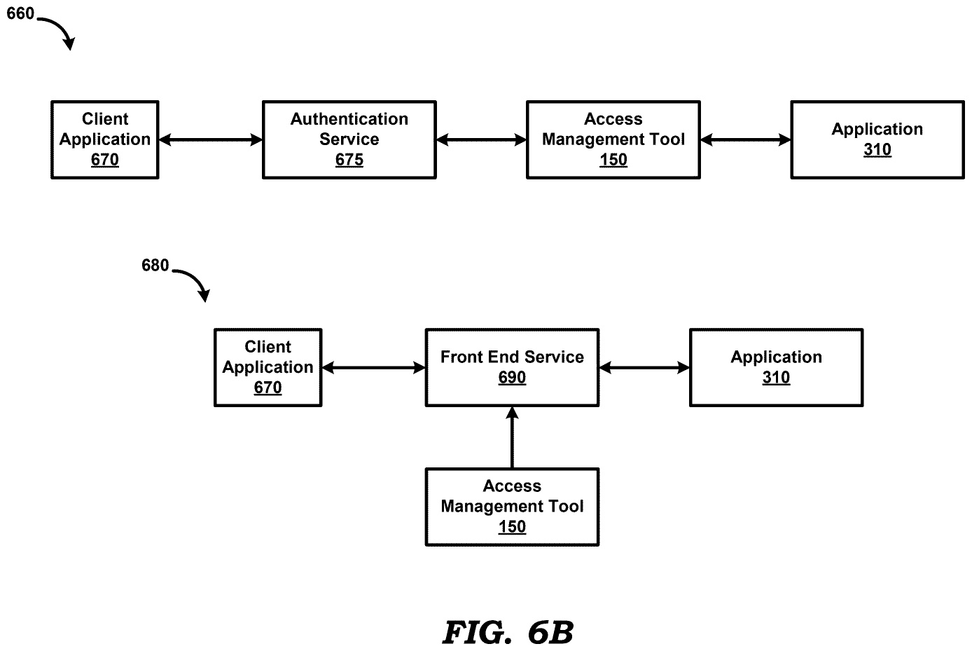

FIG. 6A is a block diagram depicting the implementation of an access management tool (150) in one embodiment. The block diagram is shown containing data interface 610, request processor 620, role creator 630, authenticator 640 and authorization controller 650. Each of the blocks in the Figure is described in detail below.

Data interface 610 facilitates other blocks of AMT 150 to store/retrieve (via path 148) data from data store 180. Request processor 620 receives (via path 121) requests from administrators using end-user systems 110 and checks whether each request is a create request for creating a custom role, an authentication request for authenticating/validating a login or an access request for performance of a management action. Request processor 620 forwards the create requests to role creator 630, authentication requests to authenticator 640 and the access requests to authorization controller 650.

Role creator 630, upon receipt of a create request (FIG. 4B), retrieves (via data interface 610) the configuration data (FIG. 4A) for application 310, and identifies based on the retrieved configuration data and the management actions specified in the create request, an effective set of resource-actions (FIG. 4D) that are to be permitted for the custom role. Role creator 630 may create a dependency graph (FIG. 4C) for identifying the effective set. Role creator 630 then stores (via data interface 610) the custom role (specified in the create request) associated with the identified effective set as part of role data (FIG. 5A). Role creator 630 also sends (via request processor 620) for display, the identified effective set to a requesting end-user system 110.

Authenticator 640, upon receipt of an authentication request specifying a login (email) and password of an administrator, retrieves (via data interface 610) portions of the user data (FIG. 5B) specific to the administrator (row 571) and authenticates the administrator based on the retrieved portions. In one embodiment, the administrator in the authentication request is deemed to be authenticated if a login and password specified in the authentication request matches the email and password (columns 565 and 566) retrieved from the user data for the administrator. Authenticator 640 sends a status (Success/Failure) of authentication as a response to the authentication request to request processor 620. If the status is a success, authenticator 640 also sends the user identifier (column 561) associated with the administrator.

Request processor 620 receives and checks the status of authentication. If the status is failure, request processor 620 sends (via path 121) a failure response to the authentication request. The failure response may indicate a reason for the failure (here, authentication failed), which may be displayed to the administrator. If the status is success, request processor 620 may send the user identifier as a success response to requesting end-user system 110. Request processor 620 may also perform other associated actions, such as session creation for the administrator, etc. as will be apparent to one skilled in the relevant arts.

Access requests may thereafter be received from successfully authenticated administrators. Each access request may specify an administrator (user identifier sent earlier) and a management action (for example, when the request is received from application UI 340 and cloud admin 360). Alternatively, the access request may specify a resource-action (for example, when the request is received from CLI 350). Though the description is continued with respect to manner in which an access request specifying a management action is processed, it may be appreciated that the same processing actions may be performed when the access request specifies a resource-action, as will be apparent to one skilled in the relevant arts by reading the disclosure herein.

Authorization controller 650, upon receipt of the access request specifying an (authenticated) administrator and a management action, first determines a custom role assigned to the administrator based on the user identifier by interfacing (via data interface 610) with user data (FIG. 5B) stored in data store 180. For the administrator of row 571, authorization controller 650 determines the custom role to be 3102 “Cluster Administrator”.

Authorization controller 650 then retrieves, from the role data (FIG. 5A), the effective set of resource-actions (column 528) permitted for the custom role (row 541). As noted above, the effective set of resource-actions for the custom role “Cluster Administrator” is shown in FIG. 4D. In the scenario that the access request is an invocation to an API exposed by application 310, authorization controller 650 also finds the management action corresponding to the invoked API by inspecting (via data interface 610) an operation data (FIG. 3B) that maps APIs to management actions.

Authorization controller 650 then checks whether the retrieved effective set of resource-actions includes the received/found management action, and sends to request processor 620 a status (allow/deny) of authorization of the access request based on whether the effective set of resource-actions includes (allow) or does not include (deny) the management action.

Request processor 620 receives and checks the status of authorization. If the status is allow, request processor 620 allows the performance of the management action and the effective set of resource-actions. Such allowance of performance may entail request processor 620 forwarding (via path 143) the access request (e.g. API invocation) to a corresponding software application (e.g., 310) deployed in nodes 160 of computing environment 130. Alternatively, request processor 620 may only forward (via path 121) the status of authorization to the request end-user system 110. If the status is deny, request processor 620 sends (via path 121) a failure response to the access request. The failure response may indicate a reason for the failure (here, authorization failed), which may be displayed to the administrator.

Thus, AMT 150 is implemented to handle create requests for creating custom roles and access requests for performance of desired management actions. AMT 150 thus provides a framework for administrators performing management actions accessing resources of a computing environment (135). The manner in which AMT 150 may be deployed in computing environment 135 is described below with examples.

FIG. 6B illustrates the manner in which an access management tool (150) is deployed in a computing environment (135) in different embodiments. In deployment 660, client 670 represents a system such as end-user systems 110 (or a client application executing therein) that facilitates an administrator to send an access request for performance of a management action. Authentication service 675 represents a third-party service (hosted on one of nodes 160) that performs authentication of the administrator sending the access request, and may be implemented similar to the operation of authenticator 640 noted above. In such a deployment, AMT 150 operates merely as an authorization service similar to the operation of authorization controller 650 noted above.

In deployment 680, front-end service 690 represents a third-party service (hosted on one of nodes 160) that performs authentication and authorization of the administrator sending the access request. In other words, AMT 150 merely performs the actions of creating/updating the role data based on the configuration data and then makes available the role data to frond-end service 690, which then performs the authentication and authorization based on the role data.

Thus, an access management tool (150) facilitating administrators to perform management actions accessing resources may be implemented and deployed in a computing environment (135). It should be noted that the operation of AMT 150 is based on the configuration data, which captures the interdependencies between different management actions as per a current state of application 310. As such, there may be scenarios where the interdependencies and correspondingly the configuration data may be changed, for example, when a new functionality is implemented in application 310. The manner in which changes to the configuration data may be handled is described below with examples.

### 9. Adding New Functionality

FIGS. 7A-7D together illustrate the manner in which a new functionality is added to the framework in one embodiment. For illustration, it is assumed that the new functionality implemented by application 310 is “Customer Managed Encryption (CMK)”.

FIG. 7A depicts portions of operation data corresponding to a new functionality in one embodiment. Data portions 710 indicates operation Id “getClusterCMK” corresponding to an API to be used for getting the CMK of a cluster, while data portion 715 indicates the management function “CMK READ” mapped to the API. Similarly, data portions 720 and 725 indicate that the operation Id/API “editClusterCMK” is mapped to the management function “CMK UPDATE”.

FIG. 7B depicts portions of configuration data corresponding to a new functionality in one embodiment. Data portion 730 indicates that the resource type to be accessed is “CMK”, while data portion 740 specifies the details of the management actions (such as CREATE, READ, etc.) and the corresponding sets of resource-actions required to be permitted/allowed.

It may be appreciated that enabling encryption is embedded in cluster creation flow, entailing that the new resource-action/permission (“CMK CREATE”) is required for an administrator if he/she wants to create or update a cluster (“CLUSTER CREATE”). Accordingly, a system administrator (managing application 310 and computing environment 135) may send (using end-user system 110) a change request for modifying the configuration data corresponding to creation of a cluster.

AMT 150 receives, from the system administrator, the change request indicating that a first set of resource-actions (FIG. 4A) currently permitted for a management action (“CLUSTER CREATE”) is to be replaced by a second set of resource-actions (FIG. 7C). The second set of resource-actions includes a new resource-action (“CMK CREATE”) corresponding to a new functionality implemented by application 310. In response to the change request, AMT 150 updates the configuration data to specify for the management action, the second set of resource-actions as described below with examples.

FIG. 7C depicts portions of configuration data updated to reflect the addition of a new functionality in one embodiment. Specifically, the configuration data of management action “CLUSTER CREATE” (of FIG. 4A) is shown updated in data portion 750 to indicate that the resource-action “CMK CREATRE” is also required to be permitted.

According to an aspect, in response to a change request, AMT 150 in addition to updating the configuration data as explained above, also updates the role data. Specifically, AMT 150 identifies custom roles stored in the role data which contains the management action (“CLUSTER CREATE”) specified in the change request. For each such custom role (for example, “Cluster Administrator”) identified, AMT 150 performs the action of identifying a new effective set of resource-actions base on the updated configuration data and stores, as part of the role data, the custom role updated to reflect the new effective set of resource-actions.

FIG. 7D depicts portions of an effective set of resource-actions updated to reflect the addition of a new functionality in one embodiment. Specifically, the effective set of resource-actions for management action “CLUSTER CREATE” (of FIG. 4D) is shown updated in data portion 760 to indicate that the resource-actions “CMK CREATE” and “CMK READ” are also required to be permitted. The updated effective set of resource actions of FIG. 7D is then stored in column 528 of row 541 to cause the custom role (in role data of table 500) to be updated.

Thus, AMT 150 handles changes to the configuration data, for example, when a new functionality is implemented in application 310. Some sample user interfaces that may be provided by AMT 150 to facilitate various aspects of the present disclosure is described below with examples.

### 10. Sample User Interfaces

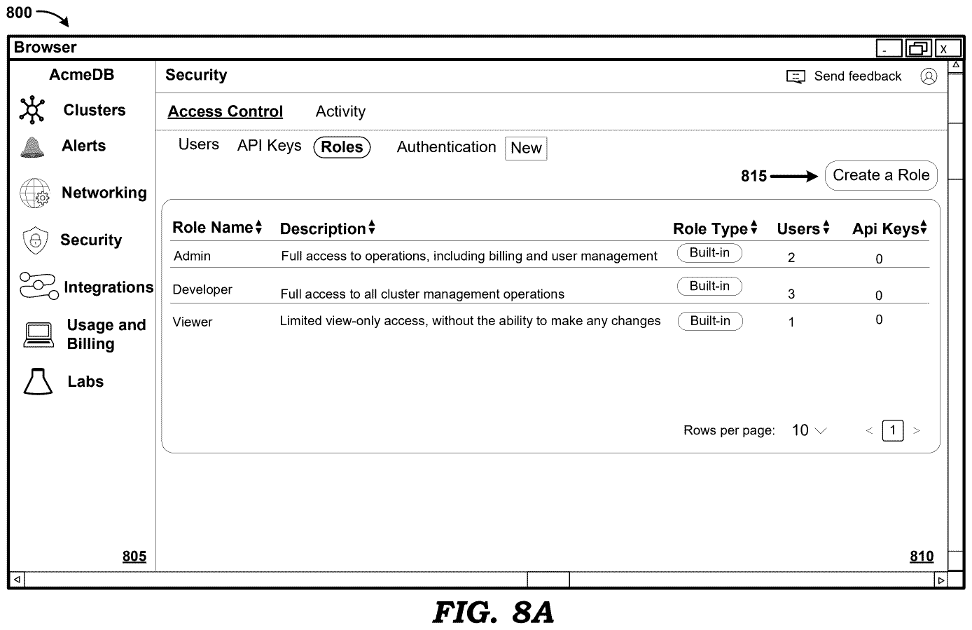

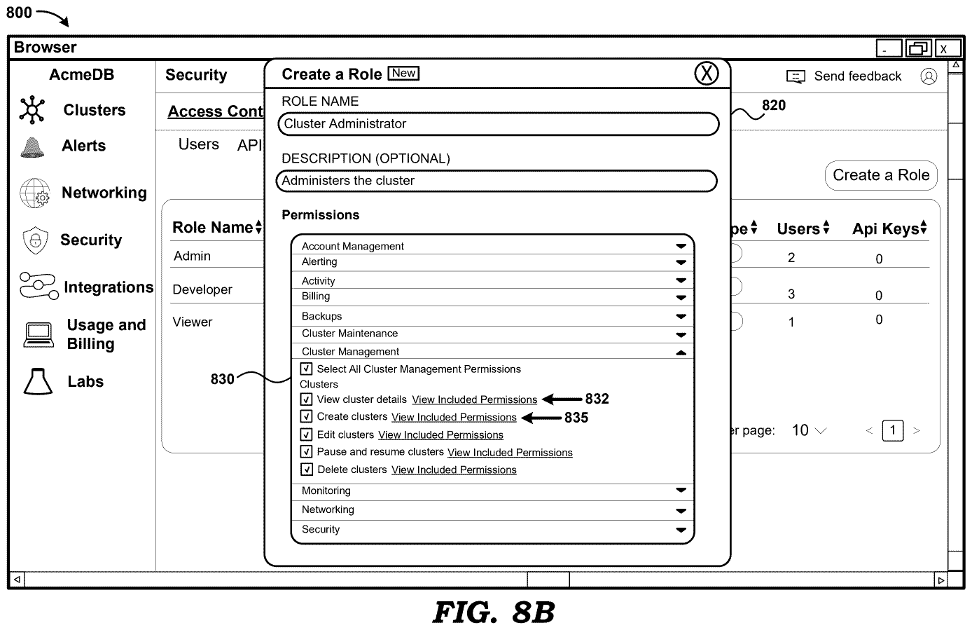

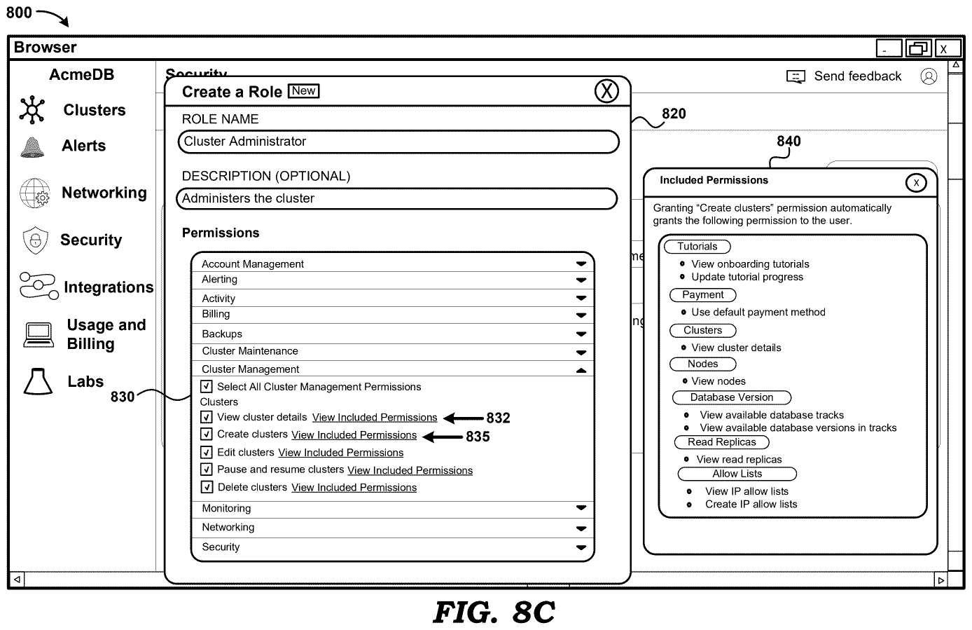

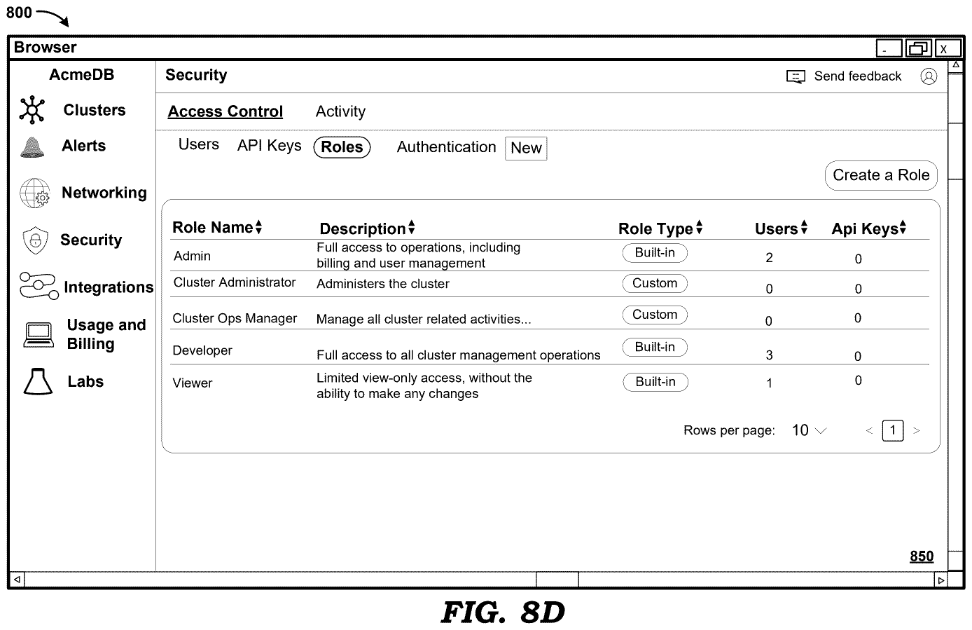

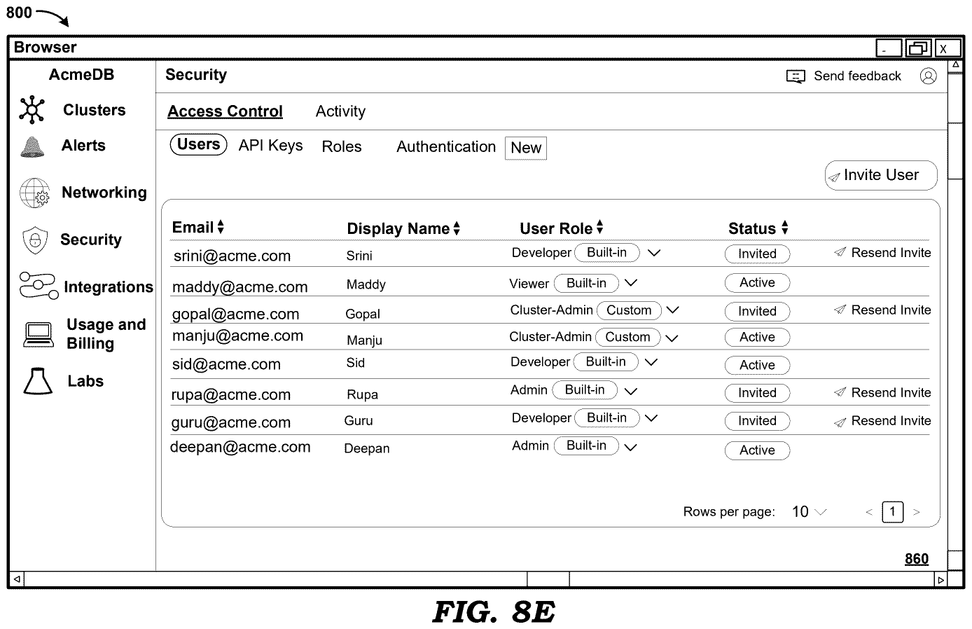

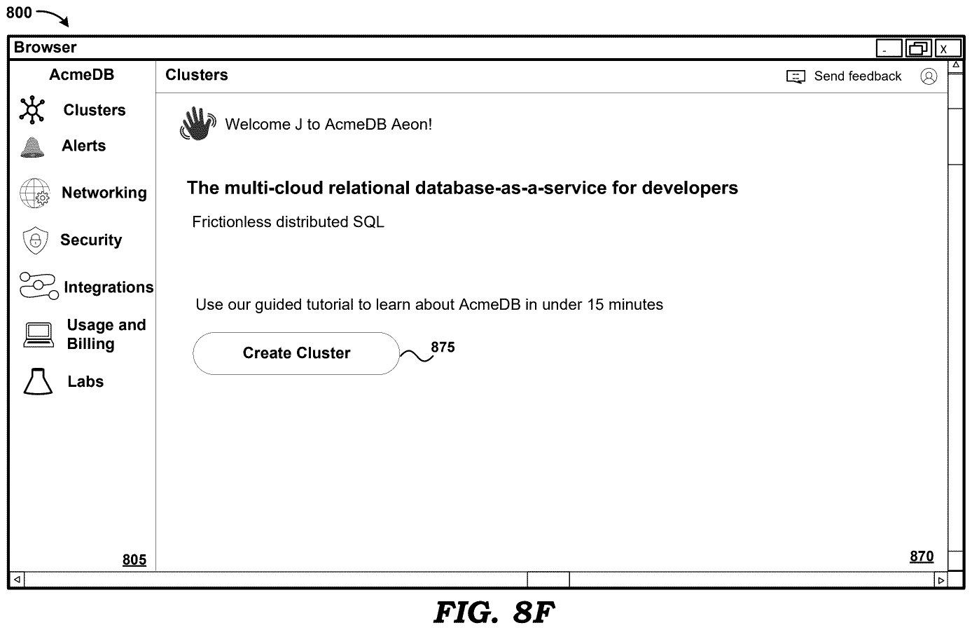

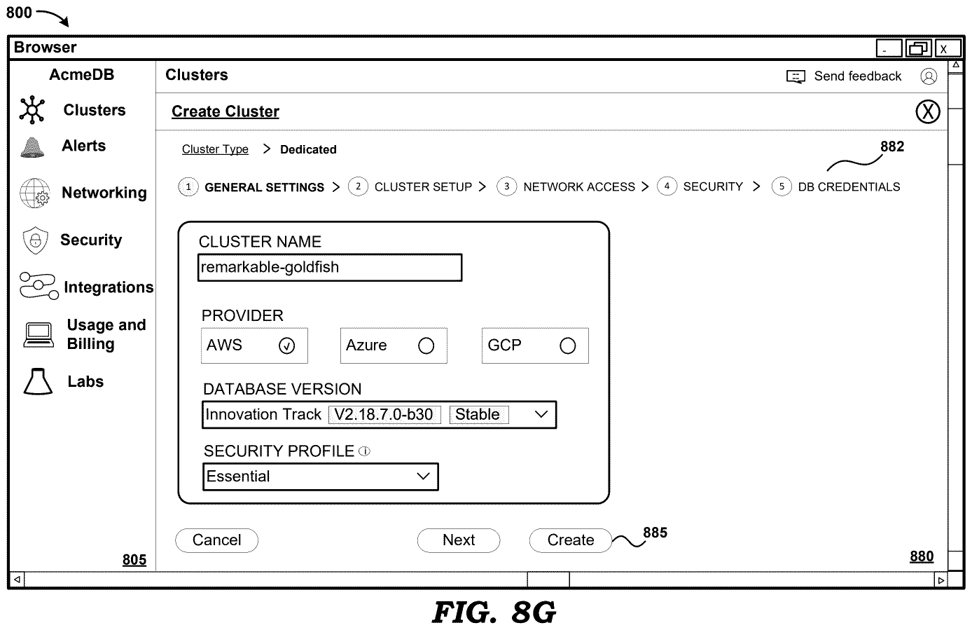

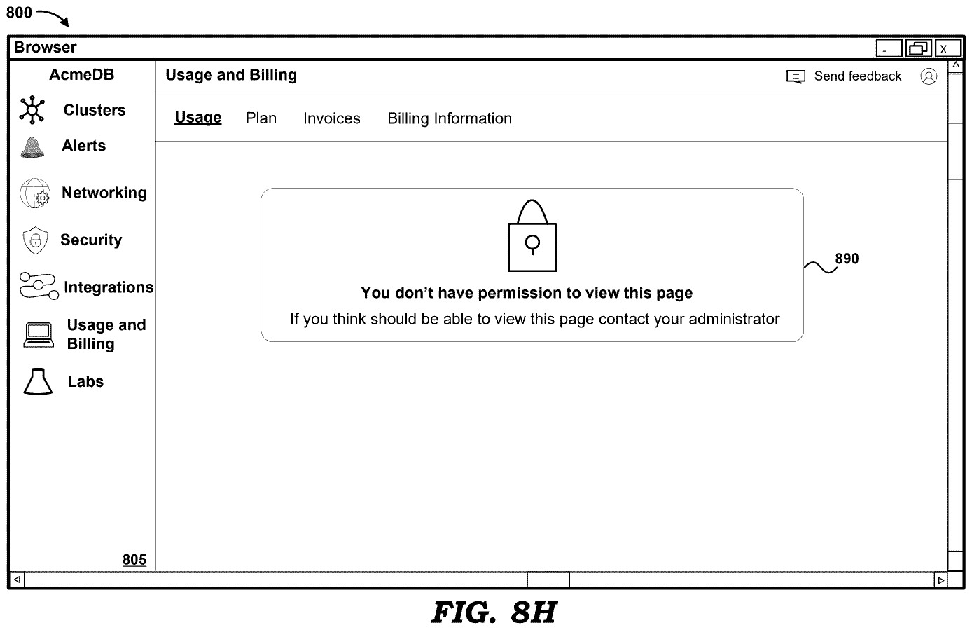

FIGS. 8A-8H illustrate sample user interfaces that provide a framework for administrators performing management actions accessing resources of a computing environment in one embodiment. Display area 800 represents a portion of a user interface displayed on a display unit (not shown) associated with one of end-user systems 110, assumed to be end-user system 110-1 for illustration. In one embodiment, each display area 800 corresponds to a web page rendered by a browser executing on the end-user system (the web pages being part of application UI 340). The web pages may be provided by AMT 150 in response to a user (e.g., administrator) sending appropriate requests (for example, by specifying corresponding Uniform Resource Locator (URL) in an address bar) using the browser.

Referring to FIG. 8A, display area 800 there depicts a portion of a user interface displayed to an authenticated administrator upon successful login (authentication). Display area 805 depicts the various options that are available to an administrator, and the description is continued assuming that the administrator has selected the “Security” option in display area 805. Display area 810 accordingly shows a user interface that facilitates administrators to manage roles of a tenant/customer. It may be observed that display area 810 displayed only predefined/built-in roles. An administrator may add desired custom roles by selecting “Create Role” button 815.

Referring to FIG. 8B, display area 820 depicts a user interface (pop-up window) displayed in response to an administrator selecting “Create Role” button 815. Display area 820 enables the administrator to specify a name (e.g., “Cluster Administrator”) and description for the custom role and to select desired permissions (management actions to be permitted) by selecting the appropriate checkboxes. Display area 830 indicates that the administrator is selecting desired permissions under “Cluster Management”, specifically that the administrator has selected all cluster management permissions.

In response to such selection, the custom role (here, “Cluster Administrator”) and the set of management actions (such as “CLUSTER READ” corresponding to view cluster details, “CLUSTER CREATE”, etc.) are sent as a create request to AMT 150, which then sends back the effective set of resource-actions to end-user system 110-1. The manner in which the effective set of resource-actions may thereafter displayed is descried in detail below.

Referring again to FIG. 8B, display area 835 depicts a link that may be selected by the administrator to view the included permissions, that is, the effect set of resource-actions identified by AMT 150 corresponding to the management action “CLUSTER CREATE”. In one embodiment, the checkboxes corresponding to the resource-actions/management actions in the effective set are selected and disabled, thereby preventing the administrator from deselecting them. As such, in display area 830, the checkbox corresponding to view cluster details (“CLUSTER READ”) is shown selected and disabled/grayed out.

Referring to FIG. 8C, display area 840 depicts a user interface (pop-up window) displayed in response to an administrator selecting “View Included Permissions” button 835. Display area 840 displays the list of permissions (effective set of resource-actions/management actions) that are automatically granted/permitted upon grant/permitting of the “CLUSTER CREATE” management action.

Referring to FIG. 8D, display area 850 depicts the user interface that facilitates administrators to manage roles of a tenant/customer similar to that of display area 810. It may be observed that display area 850 now shows two additional roles which are custom roles (such as “Cluster Administrator”) specified by the administrator using the user interfaces of FIGS. 8A-8C.

Referring to FIG. 8E, display area 860 depicts the user interface that facilitates administrators to manage users of a tenant/customer. It may be observed that different types of users have been specified by the administrator, with some users being assigned to the newly added/defined custom roles (such as “Cluster Administrator”) shown in FIG. 8D.

Thus, AMT 150 facilitates administrators to create new custom roles and assign corresponding users (administrators) to the new custom roles. The manner in which an assigned administrator is thereafter facilitated to perform management actions accessing resources is described in detail below.

Referring to FIG. 8F, display area 800 there depicts a portion of a user interface displayed to an authenticated administrator assigned the custom role “Cluster Administrator”. Display area 870 depicts a user interface that is displayed in response to an administrator selecting “Clusters” option in display area 805. Specifically, display area 870 indicates that the administrator may create a new cluster by selecting “Create Cluster” button 875.

Referring to FIG. 8G, display area 880 depicts a user interface that is displayed in response to an administrator selecting “Create Cluster” button 875. Display area 880 requires the administrator to specify various details related to the new cluster sought to be created. An administrator may select the desired one of tabs 882, specify the corresponding details, and select “Create” button 885 to initiate the management action of “CLUSTER CREATE”. In response to the selection of button 885, end-user system 110-1 sends an access request specifying the user identifier of the administrator and the management action of “CLUSTER CREATE” to AMT 150.

AMT 150, upon receipt of the access requests, retrieves and checks whether the effective set of resource-actions for the management role (“Cluster Administrator”) assigned to the administrator includes the requested management action “CLUSTER CREATE”. Upon determining that the effective set includes the requested management action, AMT 150 forwards the access request to application 310, which in turn performs the management action of creating a new cluster.

Referring to FIG. 8H, display area 890 depicts a user interface that is displayed in response to an administrator selecting “Usage and Billing” option in display area 805. Specifically, display area 890 indicates that the administrator does not have permission to view the page. It may be appreciated that upon the administrator selecting “Usage and Billing” option, end-user system 110-1 sends an access request specifying the user identifier of the administrator and a management action of “BILLING_OVERVIEW READ” to AMT 150, which in turn performs the actions of retrieving, checking and sends a response denying the performance of the management action causing display area 890 to be displayed.

It should be further appreciated that the features described above can be implemented in various embodiments as a desired combination of one or more of hardware, software, and firmware. The description is continued with respect to an embodiment in which various features are operative when the software instructions described above are executed.

### 11. Digital Processing System

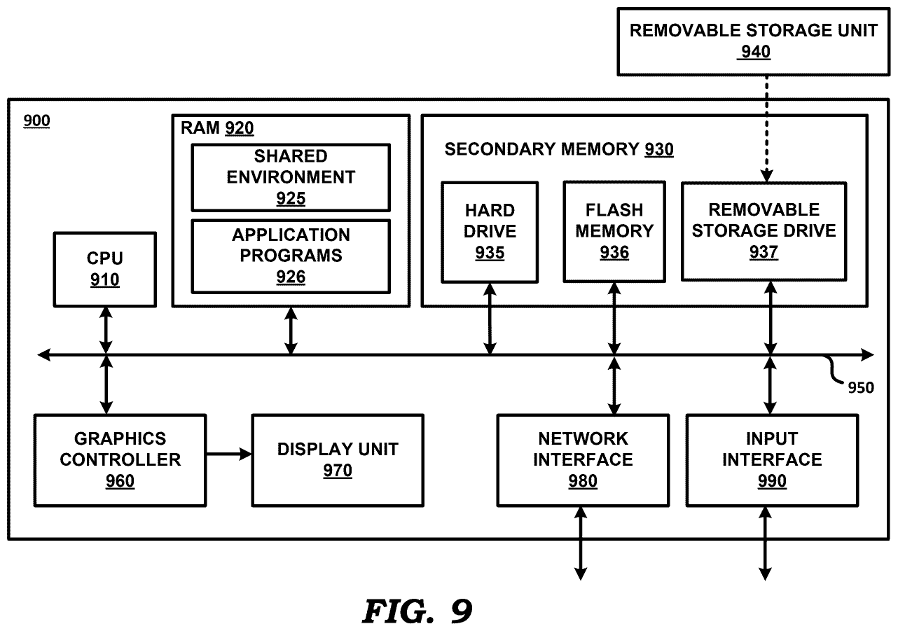

FIG. 9 is a block diagram illustrating the details of a digital processing system in which various aspects of the present disclosure are operative by execution of appropriate executable modules. Digital processing system 900 may correspond to access management tool 150 or any other system of FIG. 1.

Digital processing system 900 may contain one or more processors such as a central processing unit (CPU) 910, random access memory (RAM) 920, secondary memory 930, graphics controller 960, display unit 970, network interface 980, and input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present disclosure. CPU 910 may contain multiple processing units, with each processing unit potentially being designed for a specific task. Alternatively, CPU 910 may contain only a single general-purpose processing unit.

RAM 920 may receive instructions from secondary memory 930 using communication path 950. RAM 920 is shown currently containing software instructions constituting shared environment 925 and/or other user programs 926 (such as other applications, DBMS, etc.). In addition to shared environment 925, RAM 920 may contain other software programs such as device drivers, virtual machines, etc., which provide a (common) run time environment for execution of other/user programs.

Graphics controller 960 generates display signals (e.g., in RGB format) to display unit 970 based on data/instructions received from CPU 910. Display unit 970 contains a display screen to display the images defined by the display signals (for example, the portions of the user interfaces shown in 8A-8H). Input interface 990 may correspond to a keyboard and a pointing device (e.g., touch-pad, mouse) and may be used to provide inputs (for example, those required for the user interfaces shown in 8A-8H). Network interface 980 provides connectivity to a network (e.g., using Internet Protocol), and may be used to communicate with other systems connected to the networks.

Secondary memory 930 may contain hard drive 935, flash memory 936, and removable storage drive 937. Secondary memory 930 may store the data (e.g., data portions shown in FIGS. 3B, 4A-4D, 5A-5B and 7A-7D) and software instructions (e.g., for performing the actions of FIGS. 2A and 2B, for implementing the blocks of FIGS. 3A and 6A-6B), which enable digital processing system 900 to provide several features in accordance with the present disclosure. The code/instructions stored in secondary memory 930 may either be copied to RAM 920 prior to execution by CPU 910 for higher execution speeds, or may be directly executed by CPU 910.

Some or all of the data and instructions may be provided on removable storage unit 940, and the data and instructions may be read and provided by removable storage drive 937 to CPU 910. Removable storage unit 940 may be implemented using medium and storage format compatible with removable storage drive 937 such that removable storage drive 937 can read the data and instructions. Thus, removable storage unit 940 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 940 or hard disk installed in hard drive 935. These computer program products are means for providing software to digital processing system 900. CPU 910 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 930. Volatile media includes dynamic memory, such as RAM 920. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 950. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 12. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method for providing access to resources of a computing environment, the method comprising:
maintaining a configuration data specifying for each management action of a plurality of management actions, a corresponding set of resource-actions that are to be permitted;
receiving a create request specifying a custom role and a set of management actions permitted for said custom role, said set of management actions being contained in said plurality of management actions;
identifying based on said configuration data and said set of management actions, an effective set of resource-actions that are to be permitted for said custom role;
storing, as part of a role data, said custom role associated with said effective set of resource-actions; and
enabling said custom role to be assigned to a set of administrators, wherein each administrator in said set of administrators is permitted to perform said effective set of resource-actions in view of said identifying and said storing.

2. The method of claim 1, wherein said configuration data further specifies for each management action, a corresponding set of management actions of said plurality of management actions that are to be permitted, wherein said identifying comprises:
constructing, based on said configuration data, a dependency graph for said set of management actions, wherein said dependency graph contains start nodes representing said set of management actions, intermediate nodes representing said corresponding set of management actions and end nodes representing said corresponding set of resource-actions; and
including the management actions and the resource-actions representing all of the nodes in said dependency graph in said effective set of resource-actions.

3. The method of claim 2, wherein said create request is received from a first end-user system, said method further comprising:
sending for display, to said first end-user system, said effective set of resource-actions to indicate that each resource-action of said effective set of resource-actions is also permitted for said custom role.

4. The method of claim 1, wherein said effective set of resource-actions include said set of management actions, said method further comprising:
receiving, from an administrator of said set of administrators, an access request for performance of a management action of said plurality of management actions;
determining that said custom role is assigned to said administrator;
retrieving, from said role data, said effective set of resource-actions permitted for said custom role;
checking whether said effective set of resource-actions includes said management action; and
if said checking determines that said effective set of resource-actions includes said management action, allowing performance of said management action and said effective set of resource-actions and otherwise, denying performance of said management action.

5. The method of claim 4, wherein said access request is for performance of a resource-action, wherein said allowing allows performance of said resource-action if said effective set of resource-actions includes said resource-action.

6. The method of claim 4, wherein a software application deployed in said computing environment exposes a set of APIs (application programming interfaces), wherein said access request corresponds to invocation of an API, said method further comprising:
maintaining an operation data that maps each API of the set of APIs to a corresponding management action of said plurality of management actions; and
finding, in response to said access request, that said access request is for performance of said management action based on said operation data and said API,
wherein said checking is performed after said finding.

7. The method of claim 2, wherein said configuration data specifies for a first management action, a first set of resource-actions that are to be permitted, said method further comprising:
receiving, from a system administrator, a change request indicating that said first set of resource-actions is to be replaced by a second set of resource-actions;
updating said configuration data to specify for said first management action, said second set of resource-actions; and
for each custom role in said role data containing said first management action, performing said identifying and said storing based on said updated configuration data.

8. The method of claim 7, wherein said second set of resource-actions includes a new resource-action corresponding to a new functionality.

9. A non-transitory machine-readable medium storing one or more sequences of instructions for providing access to resources of a computing environment, wherein execution of said one or more instructions by one or more processors contained in a digital processing system cause said digital processing system to perform the actions of:
maintaining a configuration data specifying for each management action of a plurality of management actions, a corresponding set of resource-actions that are to be permitted;
receiving a create request specifying a custom role and a set of management actions permitted for said custom role, said set of management actions being contained in said plurality of management actions;
identifying based on said configuration data and said set of management actions, an effective set of resource-actions that are to be permitted for said custom role;
storing, as part of a role data, said custom role associated with said effective set of resource-actions; and
enabling said custom role to be assigned to a set of administrators, wherein each administrator in said set of administrators is permitted to perform said effective set of resource-actions in view of said identifying and said storing.

10. The non-transitory machine-readable medium of claim 9, wherein said configuration data further specifies for each management action, a corresponding set of management actions of said plurality of management actions that are to be permitted, wherein said identifying comprises one or more instructions for:
constructing, based on said configuration data, a dependency graph for said set of management actions, wherein said dependency graph contains start nodes representing said set of management actions, intermediate nodes representing said corresponding set of management actions and end nodes representing said corresponding set of resource-actions; and
including the management actions and the resource-actions representing all of the nodes in said dependency graph in said effective set of resource-actions.

11. The non-transitory machine-readable medium of claim 10, wherein said create request is received from a first end-user system, further comprising one or more instructions for:
sending for display, to said first end-user system, said effective set of resource-actions to indicate that each resource-action of said effective set of resource-actions is also permitted for said custom role.

12. The non-transitory machine-readable medium of claim 9, wherein said effective set of resource-actions include said set of management actions, further comprising one or more instructions for:
receiving, from an administrator of said set of administrators, an access request for performance of a management action of said plurality of management actions;
determining that said custom role is assigned to said administrator;
retrieving, from said role data, said effective set of resource-actions permitted for said custom role;
checking whether said effective set of resource-actions includes said management action; and
if said checking determines that said effective set of resource-actions includes said management action, allowing performance of said management action and said effective set of resource-actions and otherwise, denying performance of said management action.

13. The non-transitory machine-readable medium of claim 12, wherein a software application deployed in said computing environment exposes a set of APIs (application programming interfaces), wherein said access request corresponds to invocation of an API, further comprising one or more instructions for:
maintaining an operation data that maps each API of the set of APIs to a corresponding management action of said plurality of management actions; and
finding, in response to said access request, that said access request is for performance of said management action based on said operation data and said API,
wherein said checking is performed after said finding.

14. The non-transitory machine-readable medium of claim 10, wherein said configuration data specifies for a first management action, a first set of resource-actions that are to be permitted, further comprising one or more instructions for:
receiving, from a system administrator, a change request indicating that said first set of resource-actions is to be replaced by a second set of resource-actions;
updating said configuration data to specify for said first management action, said second set of resource-actions; and
for each custom role in said role data containing said first management action, performing said identifying and said storing based on said updated configuration data.

15. A digital processing system comprising:
a random access memory (RAM) to store instructions for providing access to resources of a computing environment; and
one or more processors to retrieve and execute the instructions, wherein execution of the instructions causes the digital processing system to perform the actions of:
maintaining a configuration data specifying for each management action of a plurality of management actions, a corresponding set of resource-actions that are to be permitted;
receiving a create request specifying a custom role and a set of management actions permitted for said custom role, said set of management actions being contained in said plurality of management actions;
identifying based on said configuration data and said set of management actions, an effective set of resource-actions that are to be permitted for said custom role;
storing, as part of a role data, said custom role associated with said effective set of resource-actions; and
enabling said custom role to be assigned to a set of administrators, wherein each administrator in said set of administrators is permitted to perform said effective set of resource-actions in view of said identifying and said storing.

16. The digital processing system of claim 15, wherein said configuration data further specifies for each management action, a corresponding set of management actions of said plurality of management actions that are to be permitted, wherein for said identifying, said digital processing system performs the actions of:
constructing, based on said configuration data, a dependency graph for said set of management actions, wherein said dependency graph contains start nodes representing said set of management actions, intermediate nodes representing said corresponding set of management actions and end nodes representing said corresponding set of resource-actions; and
including the management actions and the resource-actions representing all of the nodes in said dependency graph in said effective set of resource-actions.

17. The digital processing system of claim 16, wherein said create request is received from a first end-user system, further performing the actions of:
sending for display, to said first end-user system, said effective set of resource-actions to indicate that each resource-action of said effective set of resource-actions is also permitted for said custom role.

18. The digital processing system of claim 15, wherein said effective set of resource-actions include said set of management actions, further performing the actions of:
receiving, from an administrator of said set of administrators, an access request for performance of a management action of said plurality of management actions;
determining that said custom role is assigned to said administrator;
retrieving, from said role data, said effective set of resource-actions permitted for said custom role;
checking whether said effective set of resource-actions includes said management action; and
if said checking determines that said effective set of resource-actions includes said management action, allowing performance of said management action and said effective set of resource-actions and otherwise, denying performance of said management action.

19. The digital processing system of claim 18, wherein a software application deployed in said computing environment exposes a set of APIs (application programming interfaces), wherein said access request corresponds to invocation of an API, further performing the actions of:
maintaining an operation data that maps each API of the set of APIs to a corresponding management action of said plurality of management actions; and
finding, in response to said access request, that said access request is for performance of said management action based on said operation data and said API,
wherein said checking is performed after said finding.

20. The digital processing system of claim 16, wherein said configuration data specifies for a first management action, a first set of resource-actions that are to be permitted, further performing the actions of:
receiving, from a system administrator, a change request indicating that said first set of resource-actions is to be replaced by a second set of resource-actions;
updating said configuration data to specify for said first management action, said second set of resource-actions; and
for each custom role in said role data containing said first management action, performing said identifying and said storing based on said updated configuration data.
